(19) United States
(12) Patent Application Publication
(10) Pub. No.: US 2010/0313163 A1
(43) Pub. Date: Dec. 9, 2010

(54) IMAGE PROCESSING APPARATUS

(75) Inventors: Tatsutoshi YAMADA, Toyokawa-shi (JP); Toshikazu Higashi, Toyokawa-shi (JP); Tatsuya Eguchi, Toyohashi-shi (JP); Hiroshi Eguchi, Okazaki-shi (JP)

Correspondence Address: MORRISON & FOERSTER LLP, 1650 TYSONS BOULEVARD, SUITE 400, MCLEAN, VA, 22102, US

(73) Assignee: Konica Minolta Business Technologies, Inc., Tokyo (JP)

(21) Appl. No.: 12/793,944

(22) Filed: Jun. 4, 2010

(30) Foreign Application Priority Data
Jun. 5, 2009 (JP) 2009-136216

(51) Int. Cl. G06F 3/048

(52) U.S. Cl. 715/781; 715/853

(57) ABSTRACT

An image processing apparatus having a user interface display unit which is made up of a plurality of screens of which displaying order constitutes a hierarchical structure. The image processing apparatus includes: the user interface display unit which simultaneously displays at least two screens on a same display screen, the at least two screens including a first screen and a second screen, the first screen and the second screen being displayed with visual directions being different from each other; and a display screen determining unit which determines contents to be displayed on the first screen and the second screen, wherein the display screen determining unit determines the content of the first screen based on set contents being set in the image processing apparatus and determines the content of the second screen such that the content of the second screen has a predetermined relationship with the determined content of the first screen, and cause the user interface display unit to display the first screen and the second screen in accordance with the determinations.

This application is based on an application No. 2009-136216 filed in Japan, the contents of which are hereby incorporated by reference.

### BACKGROUND OF THE INVENTION

1. Field of the Invention

The present invention relates to an image processing apparatus, and particularly to an image processing apparatus having a user interface screen made up of a plurality of screens of which displaying order constitutes a hierarchical structure.

2. Description of the Related Art

In recent years, functions of an image processing apparatus tend to be diversified, and for example, a digital complex machine (MFP) as one example of such an image processing apparatus is an apparatus intensively having a copy function, a scanner function, a printer function, a facsimile function, a mail transmission and reception function, and the like.

In many MFPs, as a user interface device thereof, a liquid crystal display device configured integrally with a touch panel (LCD touch panel) is utilized. On the LCD touch panel of the MFP, a current status of its own machine and a key group for various types of function setting is displayed, so that an operator performs various inputs to the MFP by touching keys displayed on the panel. However, an area of a display surface of the LCD touch panel is limited, and thus, all the keys necessary for operating the MFP cannot be displayed simultaneously. The user interface device of the MFP, therefore, has a plurality of screens and switches the screens to be displayed as needed. The operator touches the LCD touch panel and, for example, selects a desired option from a menu displayed in sequence to use the various functions of the MFP.

As a technique for configuring a plurality of screens, there has been known a technique called hierarchization of screens.

In this case, a hierarchical structure is configured such that as the hierarchy of the screens becomes deeper, more detailed setting is enabled. In such MFP, a screen referred to as a base screen is prepared for each operation mode (copy, scanning, facsimile or the like). In this case, the base screen for each of the operation modes is positioned at the highest hierarchy level in the above-described hierarchical structure. Taking the copy mode as an example, the operator starts detailed setting of several functions at the copy mode base screen (see FIG. 6). When the operator touches “paper” on the copy mode base screen, the screen switches to a paper selection screen (see FIG. 7). Furthermore, by touching “settings of selected tray” on the paper selection screen, the display screen is switched to a screen of FIG. 9, so that a type of paper loaded on each paper cassette can be changed.

In this manner, the operator needs to come and go through many hierarchies until the settings for the operation mode is accomplished, which requires substantial time for the operation. Moreover, in many cases, in order to display detailed information to see set contents of the operation mode and so on, the operator is obliged to use a dedicated key.

Conventionally, a variety of techniques for structuring screens for a user interface device employing an LCD touch panel has been proposed.

JP 2002-162869 A discloses an image forming apparatus. The image forming apparatus of JP 2002-162869 A includes a display, in which a screen is switchable to a plurality of screens. In the apparatus, a function frequently used by the operator is learned, and the frequently-used function is displayed on a first screen and infrequently-used functions are displayed on a second screen or later.

In this manner, in the image forming apparatus, convenience of the operator is increased by dividing the one display screen into a plurality of regions to secure a region where the function often used by the operator is displayed.

JP 2006-178781 A discloses a display device usable as a user interface device of an image processing apparatus such as an MFP. In the display device of JP 2006-178781 A, displayed contents are moved to another position by a predetermined key operation, and a second display part is displayed in the space generated by this movement. In the second display part, new keys and the like corresponding to the above predetermined key operation are displayed.

In this manner, the display device increases the convenience of the operator by displaying the new contents corresponding to the above-described predetermined key operation while displaying the contents displayed at the time point immediately before the above-described predetermined key operation.

JP 2003-008808 A discloses a touch panel input/display device usable in an image recording apparatus. The input/display device of JP 2003-008808 A can make setting so as to simultaneously display, on a display screen, a plurality of keys corresponding to operations to an arbitrary plurality of functions included in functions that the image recording apparatus has.

The above-described configuration of the touch panel input/display device allows the plurality of functions such as facsimile, copy, scanning and the like to be simultaneously displayed on the same screen, thereby enabling the operator to operate them.

JP 2002-344683 A discloses an image processing system. The image processing system of JP 2002-344683 A includes a plurality of image processing units each provided with a display part that displays information relating to image processing. The display part in each of the image processing units receives information of a status of the other image processing unit from the relevant other image processing unit, and based on the status of the other image processing unit, the display of the display unit of its own is switched.

In the image processing system configured above, since the display of the display part of the image processing unit is switched in conjunction with the operation status of the other image processing unit, the convenience of the operation is expected to be increased when the operator uses the plurality of image processing units cooperatively.

In this manner, there are many proposals relating to apparatuses, devices and systems each having a plurality of screens as a user interface.

However, when the method of screen display made up of the plurality of screens having the hierarchized structure is employed, the operator cannot display the target screens to perform the desired operations (setting and the like) without performing many operations for screen switching. The operator therefore needs to memorize the operation procedure.

Moreover, the operator often makes erroneous setting to the image processing apparatus. Such erroneous setting may be attributed to the fact that current set values of the other setting items cannot be referred to when a certain operation is being performed on a screen in a deeper (lower) hierarchy.

Moreover, it is not uncommon that the operator loses a position in the hierarchical structure of the screen currently displayed, and that much time is often required for switching another screen.

### SUMMARY OF THE INVENTION

In order to solve the above-described problems in the related art, the present invention provides an image processing apparatus including a user interface that employs a hierarchized screen display method.

It is an object of the present invention to provide an image processing apparatus capable of simultaneously displaying screens at different hierarchical depths to thereby increase operational convenience of an operator, and solve the above-described problems in the related art.

in one aspect of the present invention, there is provided an image processing apparatus having a user interface display unit which is made up of a plurality of screens of which displaying order constitutes a hierarchical structure. The image processing apparatus includes: the user interface display unit which simultaneously displays at least two screens on a same display screen, the at least two screens including a first screen and a second screen, the first screen and the second screen being displayed with visual directions being different from each other; and a display screen determining unit which determines contents to be displayed on the first screen and the second screen, wherein the display screen determining unit determines the content of the first screen based on set contents being set in the image processing apparatus and determines the content of the second screen such that the content of the second screen has a predetermined relationship with the determined content of the first screen, and cause the user interface display unit to display the first screen and the second screen in accordance with the determinations.

### BRIEF DESCRIPTION OF THE DRAWINGS

The above and further objects and novel features of the present invention will more fully appear from the following detailed description when the same is read in connection with the accompanying drawings, and in which:

FIG. 1 is a block diagram of a hardware configuration of a digital complex machine MFP 100 according to a first embodiment of the present invention;

FIG. 2 is a block diagram of a functional configuration of the digital complex machine MFP 100 according to the first embodiment of the present invention;

FIG. 3 is an illustrative diagram for explaining multi-screen display;

FIG. 4 is a diagram explaining a principle of a multiview liquid crystal display;

FIG. 5 is a flowchart of a multi-hierarchical screen simultaneous-display processing;

FIG. 6 is an illustrative diagram of a base screen of a copy mode;

FIG. 7 is an illustrative diagram of a paper selection screen;

FIG. 8 is an illustrative diagram of the multi-screen display;

FIG. 9 is an illustrative diagram of a screen of settings of selected tray>first tray;

FIG. 10 is an illustrative diagram of the multi-screen display;

FIG. 11 is a flowchart of selective lower-hierarchical screen display processing based on an amount of an operation frequency counting;

FIG. 12 is a flowchart of a timer-driven selective lower-hierarchical screen display processing;

FIG. 13 is an illustrative diagram of the base screen of the copy mode (another example);

FIG. 14 is an illustrative diagram of a screen for setting a display content of a right screen;

FIGS. 15, 16, and 17 are illustrative diagrams of the multi-screen display;

FIG. 18 is a flowchart of screen display processing based on operator settings;

FIG. 19 is a flowchart of viewing angle control processing in accordance with displayed contents; and

FIGS. 20A and 20B are diagrams each showing a principle of viewing angle adjustment control.

It is to be expressly understood, however, that the drawings are for the purpose of illustration only and are not intended as definitions of the limits of the invention. Preferred embodiments of the present invention are described in more detail below referring to these accompanying drawings.

### DETAILED DESCRIPTION OF THE PREFERRED EMBODIMENTS

According to an embodiment of the present invention, there is provided with an image processing apparatus capable of simultaneously displaying screens which are positioned on different hierarchical depth levels, thereby bringing about an effect of increasing operational convenience of an operator.

Hereinafter, the embodiment of the present invention is described in detail.

The embodiment of the present invention is an image processing apparatus (e.g., a digital complex machine: Multi-Function Peripheral: MFP) having a user interface including a display unit capable of simultaneously providing an operator with a plurality of different screens on a same display surface in accordance with a visual direction (of an operator viewing the screen). The above-described display unit is realized by cooperative operation between an LCD touch panel using a multiview liquid crystal technology and a controller that controls the LCD touch panel. In the image processing apparatus according to the present embodiment, when a predetermined operation screen is displayed as a first screen, the control is performed so that another operation screen positioned at one-lower hierarchical level from the predetermined operation screen may be displayed as a second screen, for example. In short, the image processing apparatus according to the present embodiment presents different screens in accordance with the visual direction of the operator. In other words, the screens are displayed in different viewing angles from one another. Although viewing angles of both the screens may be partly overlapped, the viewing angles of both the screens are preferably connected without the overlapped portion and without gap therebetween. This allows the operator to operate the image processing apparatus with reference to the different screens on the same display surface only by changing his/her visual direction without any operation to the image processing apparatus required. Here, the above mentioned different screens are, for example, screens on different hierarchy levels in the above-described hierarchized structure of the user interface screen.

In the specification of the present application, the visual direction is an angle between a line of sight of the operator and a normal line of the LCD touch panel. In the specification of the present application, a parallax is a difference between visual directions when the same object (LCD touch panel) is viewed from two points different from each other.

(Hardware Configuration)

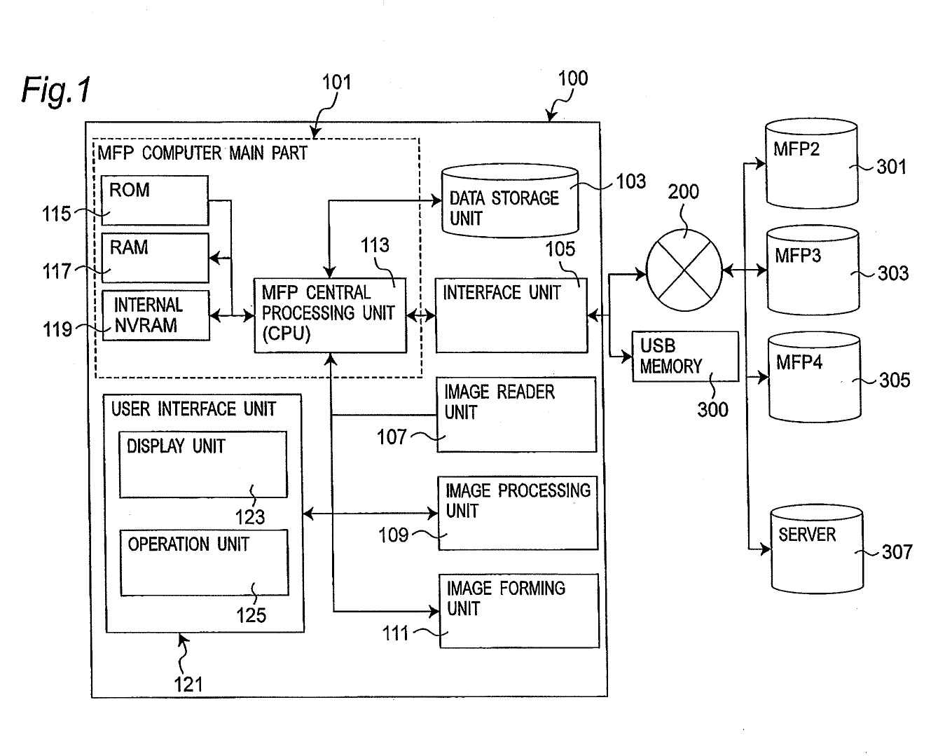

FIG. 1 is a block diagram of a hardware configuration of the image processing apparatus according to the embodiment of the present invention. The image processing apparatus according to the present embodiment is a digital complex machine (MFP). The MFP 100 includes:

a computer main part 101 that is a computer performs an arithmetic operation function, a control function, and the like;
a data storage unit 103 which holds various types of data; an interface unit 105 which performs data transmission and reception with an external apparatus;
an image reader unit 107 which reads an image to generate electronic data of the image;
an image processing unit 109 which performs various types of image processing to the electronic data of the image;
an image forming unit 111 which prints out the electronic data subjected to the image processing using an electrophotographic process; and
a user interface unit 121 which allows an operator to perform an input for settings and instructions, and displays confirmation of the set function, various warnings or the like. The computer main part 101 has a central processing unit (CPU) 113, a read only memory (ROM) 115, a random access memory (RAM) 117, and an internal nonvolatile memory (NVRAM) 119. The CPU 113 executes various programs to perform various types of data arithmetic operation processing and control processing of the MFP body. The ROM 115 holds various programs that the CPU 113 can execute. The RAM 117 holds data that the CPU 113 uses. The internal nvram 119 is used to hold data such as set modes and the like even in a case where the power is turned off. Moreover, the user interface unit 121 includes a display unit 123 to present information to the operator, and an operation unit 125 for the operator to input setting, an instruction and the like to the MFP 100. The display unit 123 includes a multiview liquid crystal, and can simultaneously present a plurality of screens to an operator. The operator changes the visual direction of his/her own to thereby refer to the plurality of screens. The operation unit 125 includes a touch panel configured integrally with the multiview liquid crystal. The interface unit 105 can communicate with other MFPs (MFP2 to MFP4 and server apparatuses (301, 303, 305, 307)) through a network 200 so as to be capable of data transmission and reception, and can transmit and receive data with respect to a portable storage device (USB memory 300 or the like). The MFP 100 according to the present embodiment can acquire various programs through the interface unit 105. Accordingly, programs for realizing actions described later and the like can be acquired through the interface unit 105, and can be executed.

(Functional Configuration)

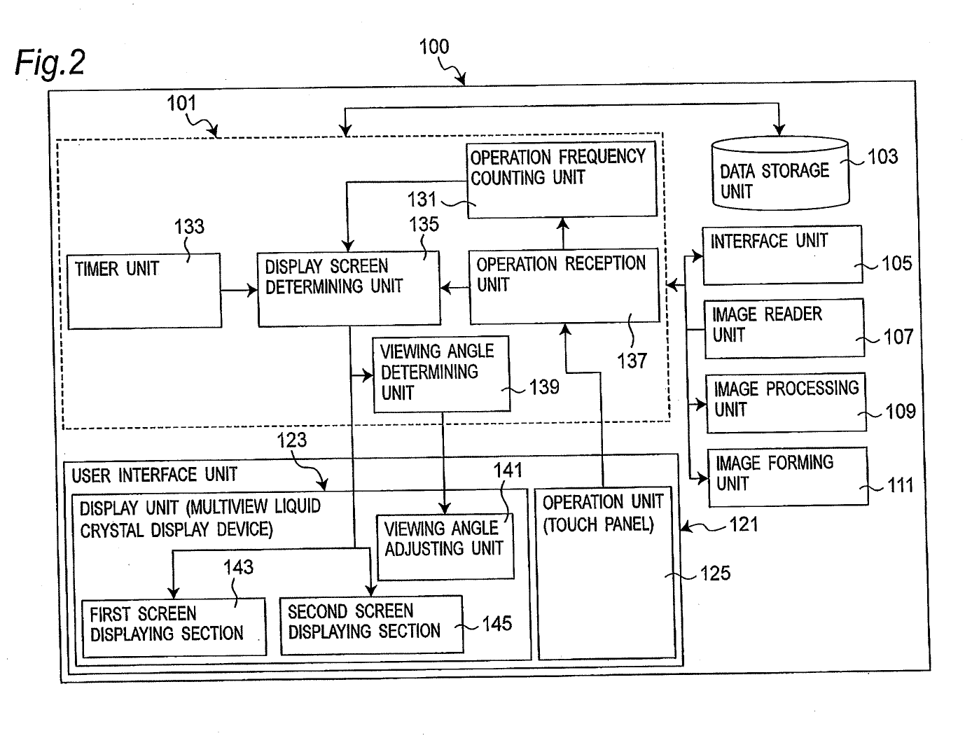

FIG. 2 is a block diagram of a functional configuration of the MFP 100 according to the present embodiment. The functions are realized by cooperative operations of the hardware components shown in FIG. 1 and the programs executed in the computer main part 101.

The MFP 100 includes:

an operation frequency counting unit 131 which records contents of operations performed by the operator and counts (tabulates) frequencies at which the respective operations are used;
a timer unit 133 which outputs information of time from a certain time being as an origin;
a display screen determining unit 135 which determines a screen(s) to be displayed on the display unit 123;
an operation reception unit 137 which receives an operation which the operator performs to the operation unit 125;
a viewing angle determining unit 139 that determines a viewing angle for the respective plurality of screens making up the display of the display unit 123;
a viewing angle adjusting unit 141 which adjusts the viewing angle of the display unit, based on a value of the viewing angle determined by the viewing angle determining unit 139; and
a first screen displaying section 143 and a second screen displaying section 145 each of which displays the screen determined by the display screen determining unit 135 at the viewing angle determined by the viewing angle determining unit 139. The display screen determining unit 135 determines the contents of the plurality of screens to be displayed on the display unit 123 made of the multiview liquid crystal, and outputs the contents to the display unit 123. The viewing angle determining unit 139 determines the viewing angle of a first screen displayed on the first screen displaying section 143 and the viewing angle of a second screen displayed on the second screen displaying section 145. The viewing angle adjusting unit 141 adjusts a parallax barrier of the multiview liquid crystal and the like to adjust the viewing angles of the first and second screens. The viewing angle is a range in the visual direction where the operator can refer to the screen.

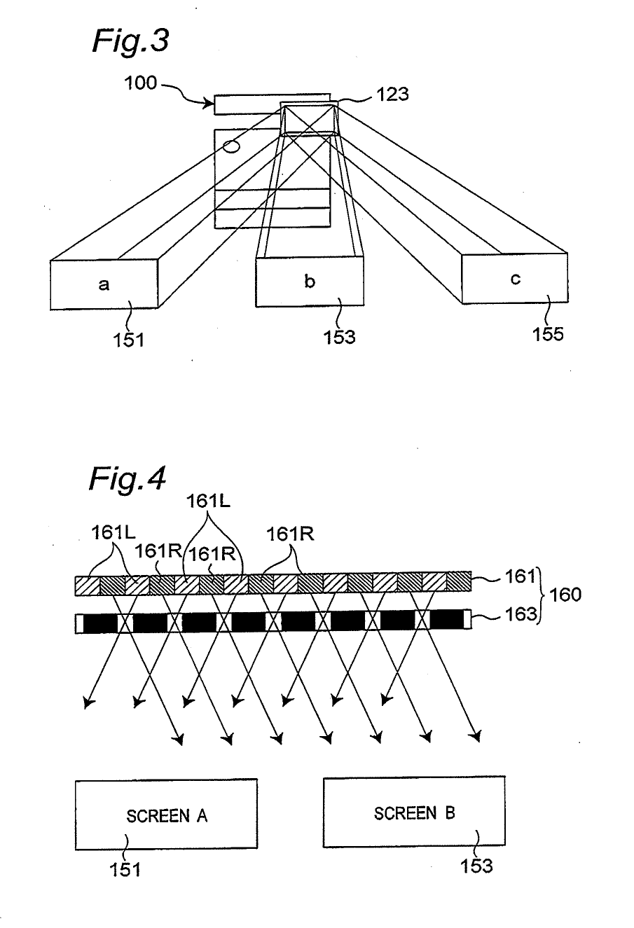

FIG. 3 is an overview diagram of multi-screen display in the display unit 123 of the MFP 100 according to the present embodiment. The MFP 100 simultaneously displays the plurality of screens on the display unit 123 at a time. The operator can refer to one of the plurality of the screens by changing the visual direction to the display unit 123. For example, a first screen 151 is displayed at a viewing angle located leftmost with respect to a horizontal direction in the drawing. A second screen 153 can be referred to at a central viewing angle. A third screen 155 is displayed at a viewing angle located rightmost. The operator can refer to the above-described three types of screens 151, 153, and 155 on the same display surface substantially simultaneously (with no operation required) by changing the visual direction.

FIG. 4 is a diagram showing a display principle of the multi-screen display of the display unit 123. A multiview liquid crystal 160 of the display unit 123 has pixels 161 and a parallax barrier 163. In this figure, for simplicity, the multiview liquid crystal 160 is capable of displaying two screens at a time. Here, as to the pixels 161, pixels for the first screen display 161L and pixels for the second screen display 161R are arranged alternately in a predetermined direction. The pixels for the first screen display 161L are used to display the first screen 151 (FIG. 3), and the pixels for the second screen display 161R are used to display the second screen 153 (FIG. 3). Thus, in the pixels 161, the first screen and the second screen are displayed in a striped manner in a predetermined direction. A slit (filter) called as parallax barrier 163 is arranged between the pixels 161 and the operator. The parallax barrier 163 has portions that transmit light and portions that block off light. Therefore, in a predetermined direction, the light emitted from the pixels 161 can be transmitted to the opposite side of the parallax barrier 163 with respect to the pixels 161, while in a direction other than the predetermined direction, the light cannot be transmitted to the opposite side of the parallax barrier 163 with respect to the pixels 161. In this manner, the parallax barrier 163 blocks off the propagation of the light from the pixels 161 in a predetermined direction, by which the viewing angle at which the operator can visually recognize the light from the respective pixels can be controlled. Here, the light emitted from the pixels for the first screen display 161L can be propagated only to the left side in the horizontal direction of the drawing, and the light emitted from the pixels for the second screen display 161R can be propagated only to the right side. Thus, in the left visual direction in the horizontal direction of the figure, the operator visually recognizes a screen A (the first screen 151), and in the right visual direction in the same, the operator visually recognizes a screen B (the second screen 153).

(Flowchart of Multi-Hierarchical Screen Simultaneous-Display Processing)

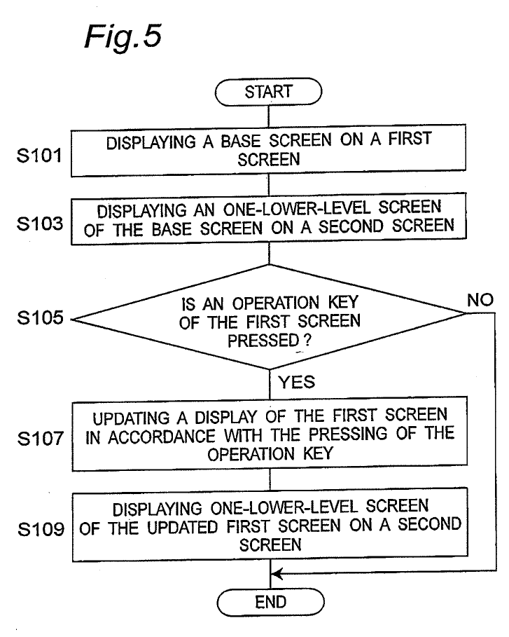

FIG. 5 is a flowchart of the processing relating to simultaneous display of multi-hierarchical screens in the image processing apparatus according to the present embodiment. In this example, two screens (first and second screens) are displayed as the multi-screen display (see FIG. 4).

In step S101, the MFP 100 displays a base screen as the first screen 151 (FIGS. 3 and 4) on the display unit 123. In a more general expression for this step, the MFP 100 determines display contents of the first screen 151 based on currently set contents in the MFP 100 (a current operation mode, a last operation input by the operator and the like). Here, the base screen is a screen located in a highest hierarchy level in respective operation modes.

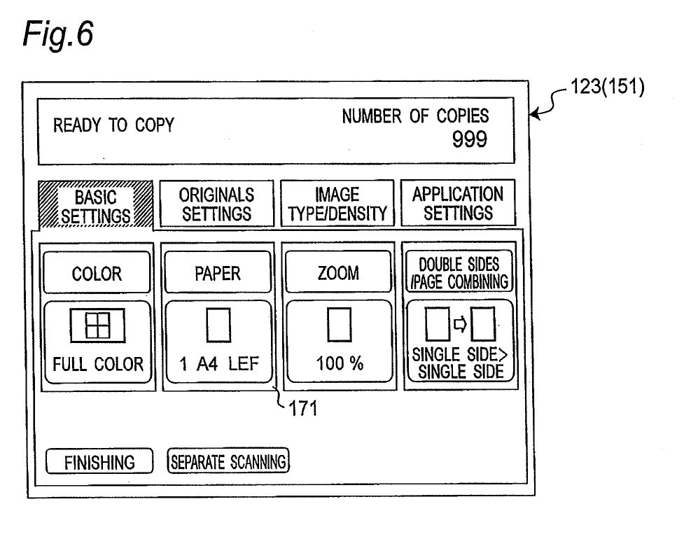

FIG. 6 shows, as an example of the base screen, the base screen for a copy operation mode. In step S101, the base screen is displayed as the first screen 151.

Referring back to FIG. 5 again, in step S103, the MFP 100 displays, as the second screen 153 (FIGS. 3, 4), a one-lower-level screen than the base screen on the display unit 123.

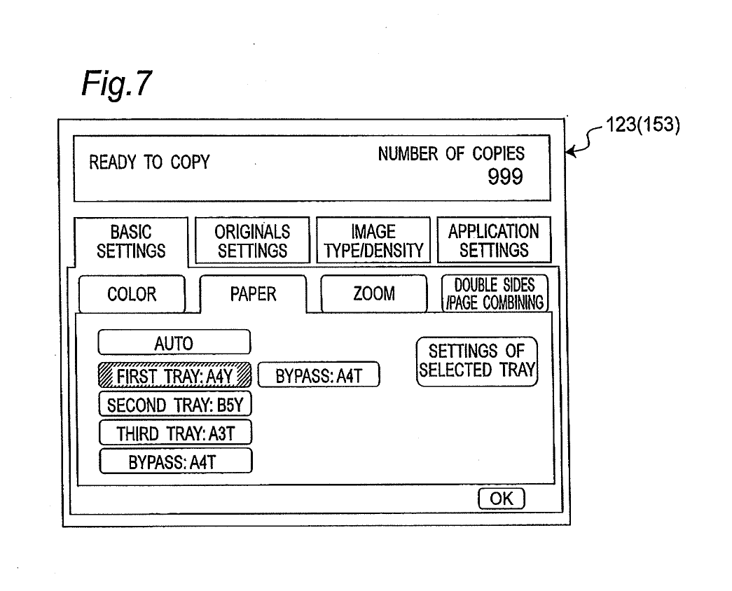

FIG. 7 shows, as an example of the one-lower-level screen than the base screen, a paper selection screen. The paper selection screen is a one-lower-level screen than the base screen, which is selected by pressing a “paper” key 171 of the base screen in FIG. 6.

In this manner, the MFP 100 controls the display of the display unit 123 so that one of the screens is a one-lower-level screen which is selectable at the other screen of the multi-screen display being made up of two screens. When there are two or more one-lower-level screens selectable from the other screen, one of them may be displayed.

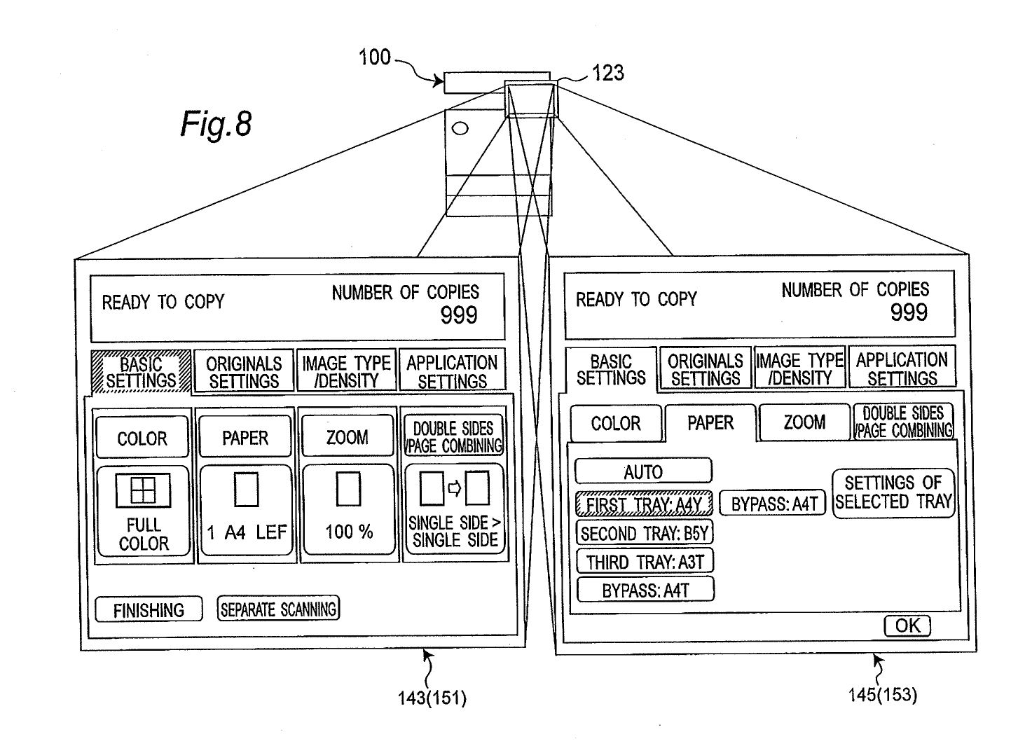

FIG. 8 is an illustrative diagram showing a situation of the multi-screen display in the MFP 100 according to the present embodiment. In this situation, when the operator refers to the display unit 123 from the left side in the figure, the operator can refer to the copy operation mode base screen, and when the operator refers to the display unit 123 from the right side in the figure, the operator can refer to the one-lower-level screen “paper selection screen”, which is selectable from the copy operation mode base screen.

Referring back to FIG. 5, in step S105, the MFP 100 determines whether or not an operation key of the first screen has been pressed. If the MFP 100 determines that the operation key of the first screen has been pressed (“YES” in step S105), the processing shifts to the step S107. If the MFP 100 determines that any operation key of the first screen has not been pressed (“NO” in step S105), the processing ends.

In step S107, the MFP 100 updates the display of the first screen 151 in accordance with the contents set in the pressed operation key of step S105. For example, it is assumed that the “paper” key 171 on the first screen 151 is pressed. In this case, the MFP 100 displays the “paper selection screen” (see FIG. 7) as the first screen 151.

In step S109, the MFP 100 displays, on the second screen 153, a one-lower-level screen than the hierarchy level of the screen displayed on the first screen 151. For example, if the “paper selection screen” (FIG. 7) is displayed as the first screen, a “screen of settings of selected tray”, which is a one-lower-level screen being selectable from the “paper selection screen”, is displayed on the second screen 153.

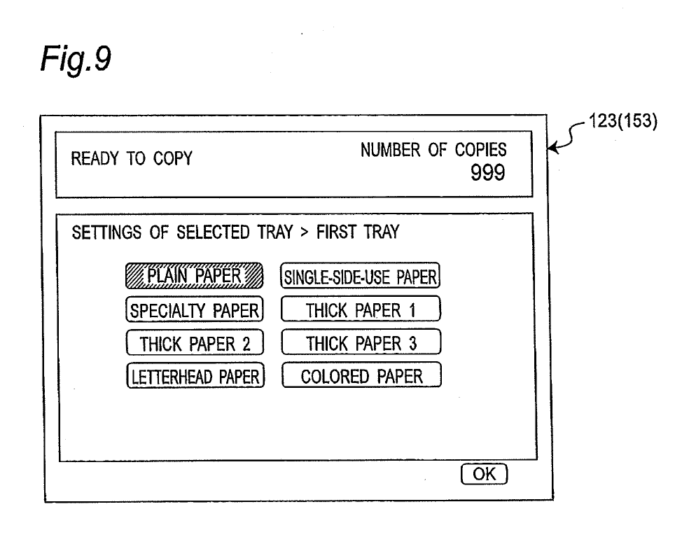

FIG. 9 is a diagram showing a “screen of settings of selected tray>first tray”, which is an example of the one-lower-level screen from the “paper selection screen” (FIG. 7). In this manner, when the display of one of the screens is changed by the operation of the operator to the one of the screens, the MFP 100 always displays, on the other screen, the one-lower-level screen being selectable from the one screen. This allows the operator to simultaneously (without performing any operation to the MFP 100,) refer to the screens of the plurality of hierarchy levels by changing the visual direction, which enables the setting operation with ease.

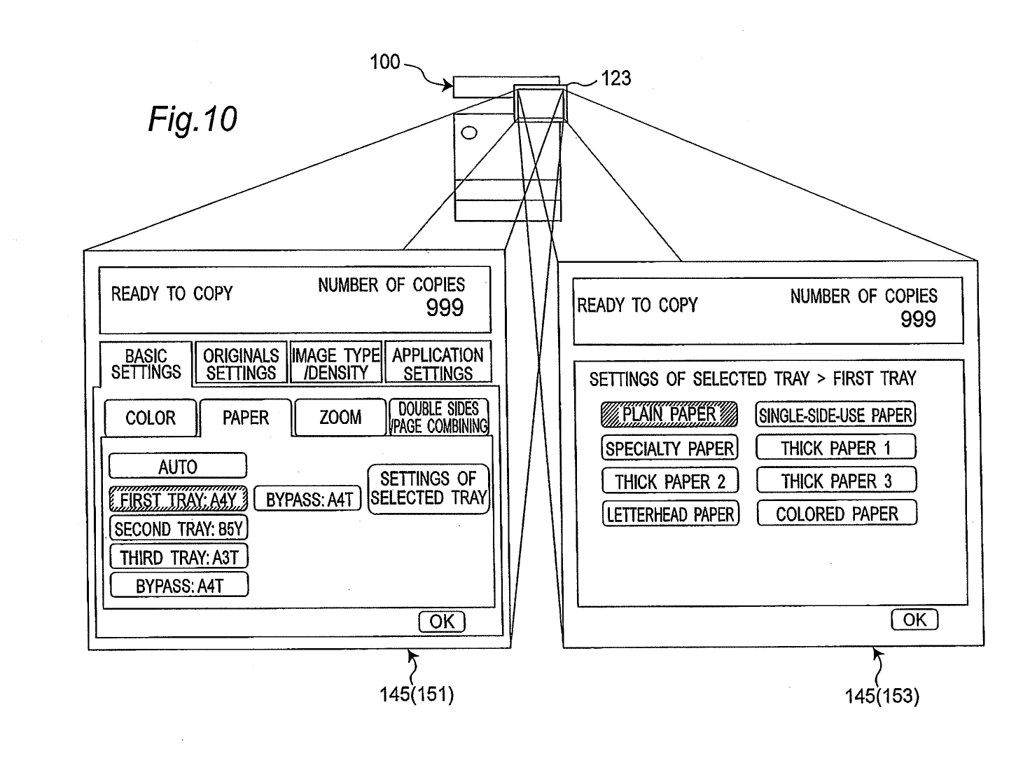

FIG. 10 is an illustrative diagram showing a situation of the multi-screen display in the MFP 100 according to the present embodiment. In this situation, when the operator refers to the display unit 123 from the left side of this figure, the operator can refer to the “paper selection screen”, and when the operator refers to the display unit 123 from the right side of this figure, the operator can refer to the one-lower-level screen “screen of settings of selected tray>first tray” which is selectable from the “paper selection screen”.

In the MFP 100 according to the present embodiment, the first screen 151 (first screen displaying section 143) and the second screen 153 (second screen displaying section 145) share the operation unit (touch panel) 125. Accordingly, in a relationship between the screens displayed on the first screen displaying section 143 and the second screen displaying section 145 at a time, the operation keys arranged on both the screens are arranged so that positions thereof are displaced from one another. This enables the MFP 100 to exactly know to which operation key of which screen is operated thorough the operation onto the touch panel.

(Flowchart of Selective Lower-Hierarchical Screen Display Processing Based on an Amount of Operation Frequency Counting)

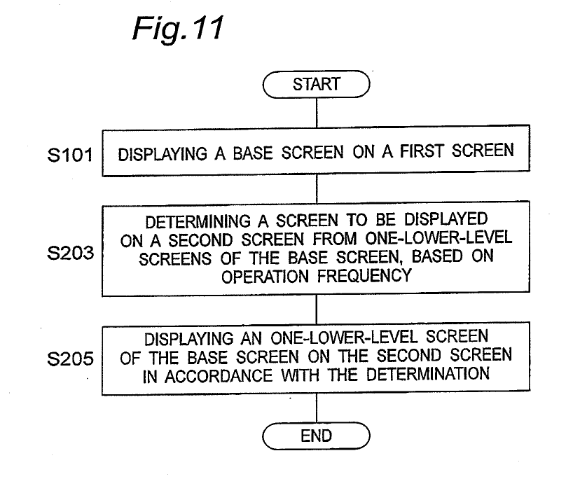

Next, referring to FIG. 11, processing for selecting a screen to be displayed on the display unit 123 from the plurality of screens in case that there is a plurality of lower-hierarchical screens is described.

FIG. 11 is a flowchart of selective lower-hierarchical screen selection based on an amount of operation frequency counting.

In step S101, the MFP 100 displays the base screen (FIG. 6) as the first screen 151 (FIGS. 3, 4) on the display unit 123. Referring to FIG. 6, it is understood that as the one-lower-level screens being selectable from the base screen, there are a color selection screen, the paper selection screen, a zoom setting screen, a double sides/page combining setting screen and the like.

The MFP 100, in step S203, derives a priority order of the lower-level screens for displaying the second screen 153, and configures the second screen 153 in accordance with the derived priority order. The priority order is decided in a way that a screen having higher possibility for being used is given a higher priority. Here, the possibility for being used is determined based on past operation record (past actual performance of operations). Specifically, the MFP 100 refers to the operation frequency count amount outputted by the operation frequency counting unit 131 to derive the priority order. The operation frequency counting unit 131 can output an amount indicating the operation frequency of the past operations by the operator. It is preferable for the amount to be a predetermined amount of statistics.

In step S205, the MFP 100 displays the lower-level screen having the higher priority order on the second screen displaying section 145 of the display unit 123 as the second screen 153.

As described, when the plurality of lower-level screens are exist, the lower-level screen to be displayed as the second screen 153 is determined. The operator can refer to the lower-level screen that the operator actually needs to operate simultaneously with the base screen without any operation to the MFP 100.

(Flowchart of Timer-Driven Selective Lower-Hierarchical Screen Display Processing)

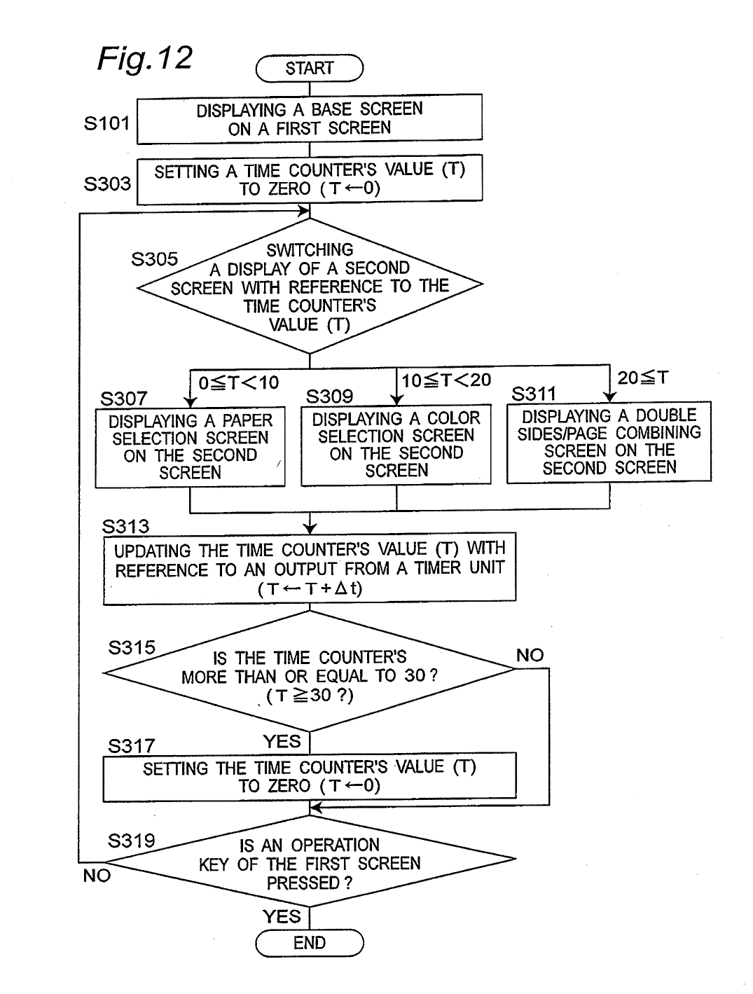

Below, another mode for displaying a lower-level screen is described, in which the screen to be displayed as the lower-level screen is automatically switched with time. FIG. 12 is a flowchart of a timer-driven selective lower-hierarchical screen display processing.

In step S101, the MFP 100 displays the base screen (FIG. 6) as the first screen 151 (FIGS. 3, 4) on the display unit 123. Referring to FIG. 6, it is understood that the color selection screen, the paper selection screen, the zoom setting screen, the double sides/page combining setting screen and the like are present as the one-lower-level screens which is selectable from the base screen.

In step S303, the MFP 100 sets a value (T) of a time counter to zero. At this time, the MFP 100 stores a value outputted from the timer unit 133 so as to make a correlation of the value T=zero.

In step S305, the MFP 100 branches the processing based on the value T of the time counter. For example, if the value T of the time counter is more than or equal to zero and less than 10 (the unit may be, for example, a “second”), the processing shifts to step S307, if the value T of the time counter is more than or equal to 10 and less than 20, the processing shifts to step S309, and if the value T of the time counter is more than or equal to 20, the processing shifts to step S311.

In step S307, the paper selection screen (FIG. 7) is displayed as the second screen 153.

In step S309, the color selection screen (not shown) is displayed as the second screen 153.

In step S311, double sides/page combining setting screen (not shown) is displayed as the second screen 153.

As described, regarding the one-lower-level screens which is selectable from a screen displayed on one of the screens, the MFP 100 sequentially displays them by temporally switching the one-lower-level screens to be displayed. In the present example, the “paper selection screen”, the “color selection screen”, and the “double sides/page combining setting screen”, which are the lower-level screens of the base screen, are automatically switched at a periodic interval in this order. This is because it is considered that when the operator makes setting of a copy job, he or she often performs the setting operation in the order of selecting paper, selecting a color and making the double sides/page combining setting. Thus, automatic temporal switching of the second screen 153 allows the operator to finish the series of the setting operations by performing the setting operations in this order, and thus, the operator is not at a loss to operate during the setting operations. When the screen other than the base screen is displayed on the first screen 151 or on the second screen 153, to the similar effect, the one-lower-level screens displayed on the other screen may be switched temporally to contribute to the convenience of the operator.

In step S313, the MFP 100 updates the value T of the time counter with reference to the output of the timer unit 133. When the unit of the value T is a “second”, the value T is updated using a difference (second) between the output of the timer unit 133 in step S313 and the output of the timer unit 133 at T=zero.

In step S315, the MFP 100 determines whether the value T of the time counter is more than or equal to 30. If the MFP 100 determines that the value T of the time counter is more than or equal to 30 (“YES” in step S315), the processing shifts to step S317. If the MFP 100 determines that the value T of the time counter is less than 30 (“NO” in step S315), the processing shifts to step S319 with step S317 skipped.

In step S317, the MFP 100 resets the value T of the time counter. The processing in step S317 may be performed similarly to the processing in step S303. Here, the MFP 100 resets the value T of the time counter in a period of 30 seconds because the three types of lower-level screens are switched at intervals of 10 seconds. In the case of a period different from that of 30 seconds, in step S317, when the value T of the time counter exceeds a value corresponding to the period, the value of the time counter may be reset.

In step S319, the MFP 100 determines whether there has been an operation to the first screen 151. If the operation to the first screen is performed (“YES” in step S319), the processing ends. As long as the operation to the first screen is not performed (“NO” in step S319″), the processing returns to step S305 to be looped.

(Processing for Displaying a Screen Based on Operator's Setting)

In the MFP 100 according to the present embodiment, the operator can, in advance, set which screens are to be displayed as the second screen 153. In this case, the second screen 153 may not be the one-lower-level screen which is selectable from the first screen 151 in the relationship with the first screen 151.

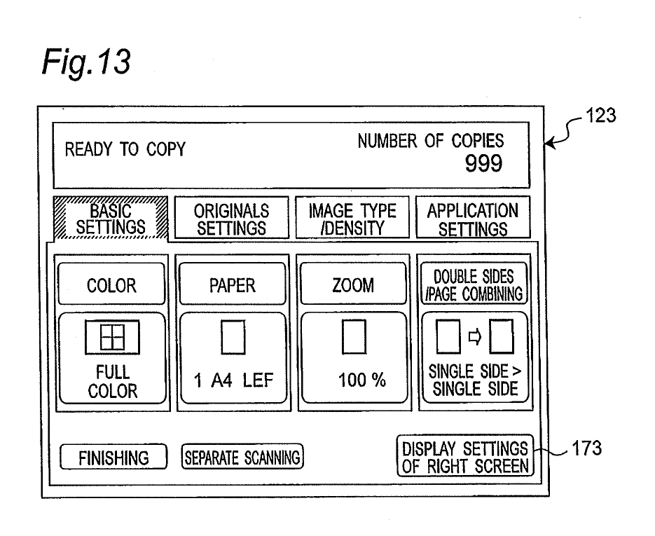

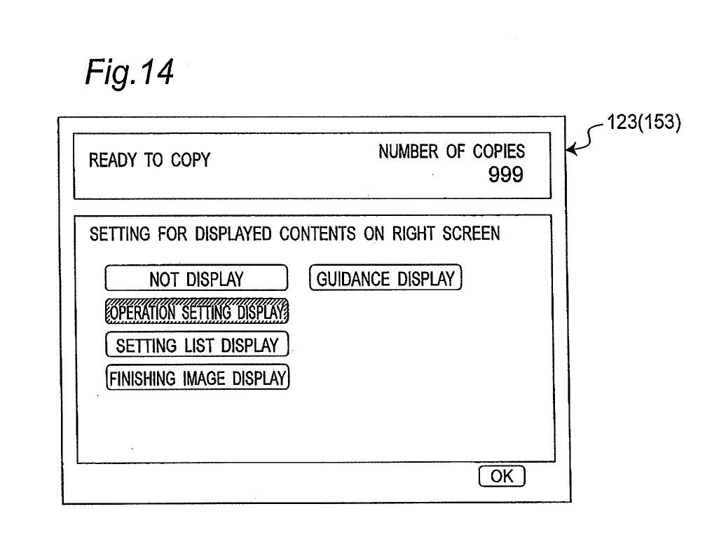

FIG. 13 is a diagram showing an example of the base screen in the copy operation mode. On the base screen, an operation key “display settings of right screen” 173 is provided. Here, the right screen indicates the second screen 153. An example of a screen displayed when the operation key 173 is pressed is shown in FIG. 14. The screen shown in FIG. 14 may be displayed on either of the first and second screens.

FIG. 14 shows a screen for the display content settings of the right screen. The operator selects any one of operation keys of “not display”, “operation setting display”, “setting list display”, “finishing image display”, and “guidance display” to thereby specify the screen to be displayed on the second screen 153. When the operation key of “not display” is selected, nothing is displayed on the second screen 153. When the operation key of “operation setting display” is selected, one of the lower-level screens being selectable from the first screen 151 is displayed as the second screen 153, as described with reference to FIG. 8.

(Setting List Screen Display)

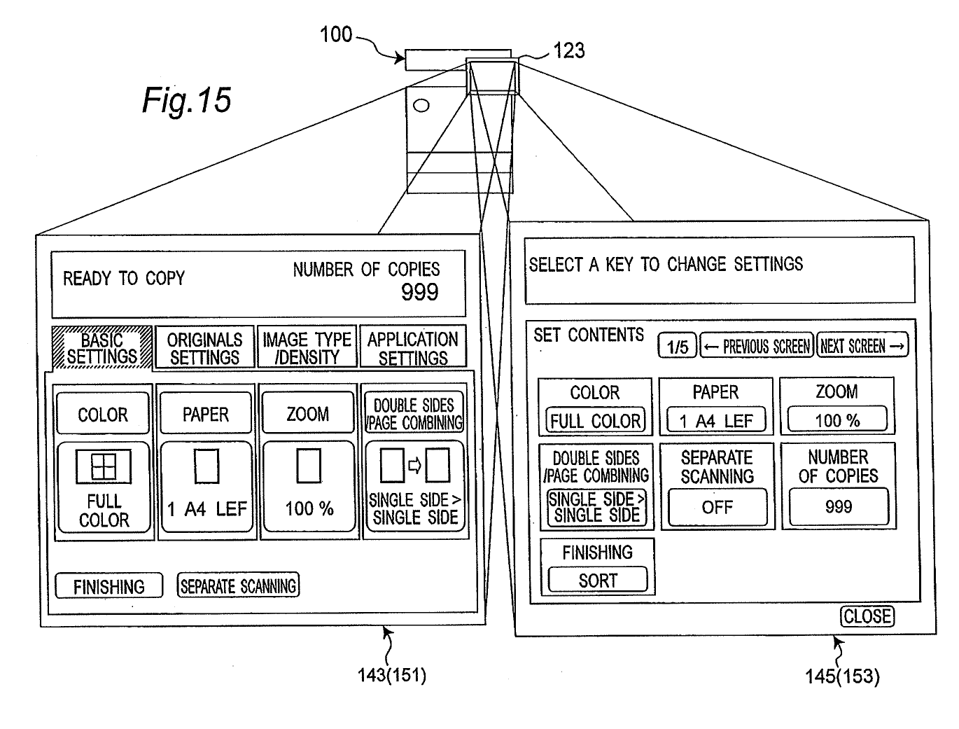

FIG. 15 is an illustrative diagram of a setting list display screen displayed on the second screen 153 when the operation key of “setting list display” is selected. As depicted, a list of values currently set is displayed on the second screen 153.

(Finishing Image Display)

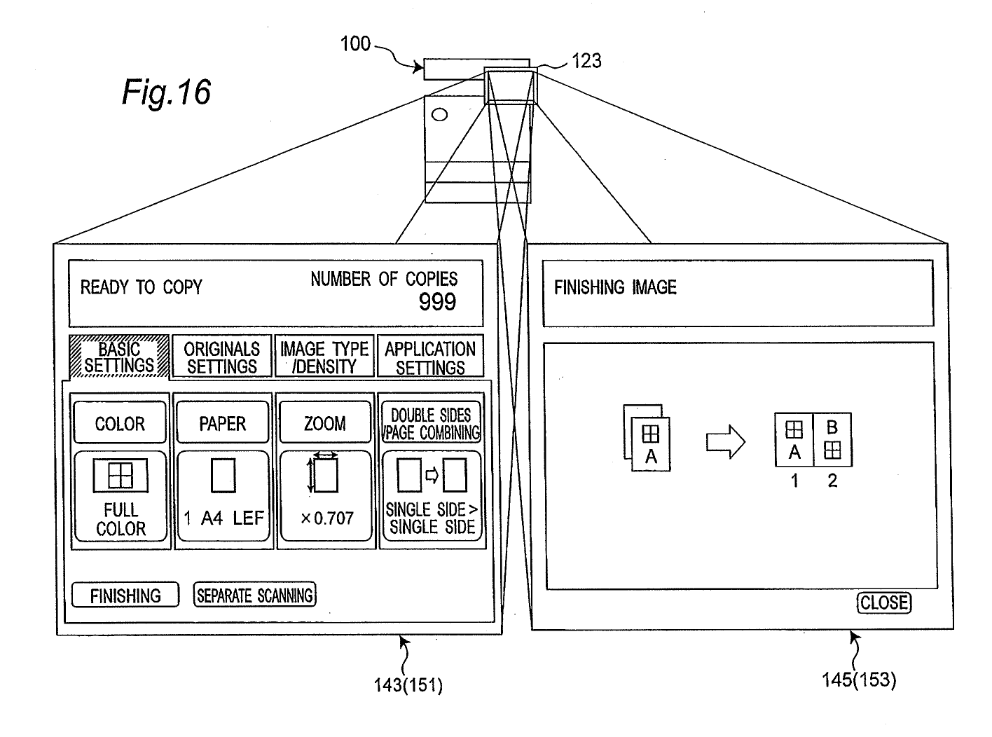

FIG. 16 is an illustrative diagram of a finishing image display screen displayed on the second screen 153 when the operation key of “finishing image display” is selected. As depicted, on the second screen, a finishing image of a job when executed with the values currently set is displayed graphically. In FIG. 16, “2 in 1” has been selected in the “page combining” of the first screen 151, and in response to this, a finishing image in which images of two pages are combined into one page is displayed on the second screen 153.

(Guidance Screen Display)

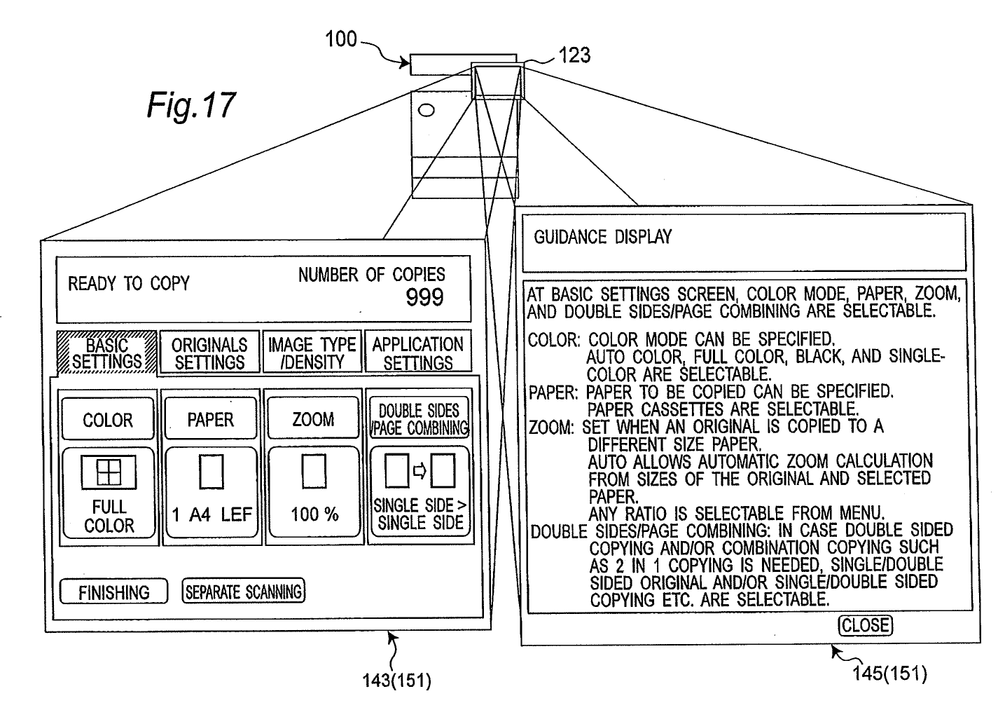

FIG. 17 is an illustrative diagram of a guidance display screen displayed on the second screen 153 when the operation key of “guidance display” is selected. As depicted, on the second screen, a guidance relating to the contents currently displayed as the first screen 151 is displayed.

(Flowchart of the Processing for Screen Display Processing Based on Operator's Setting)

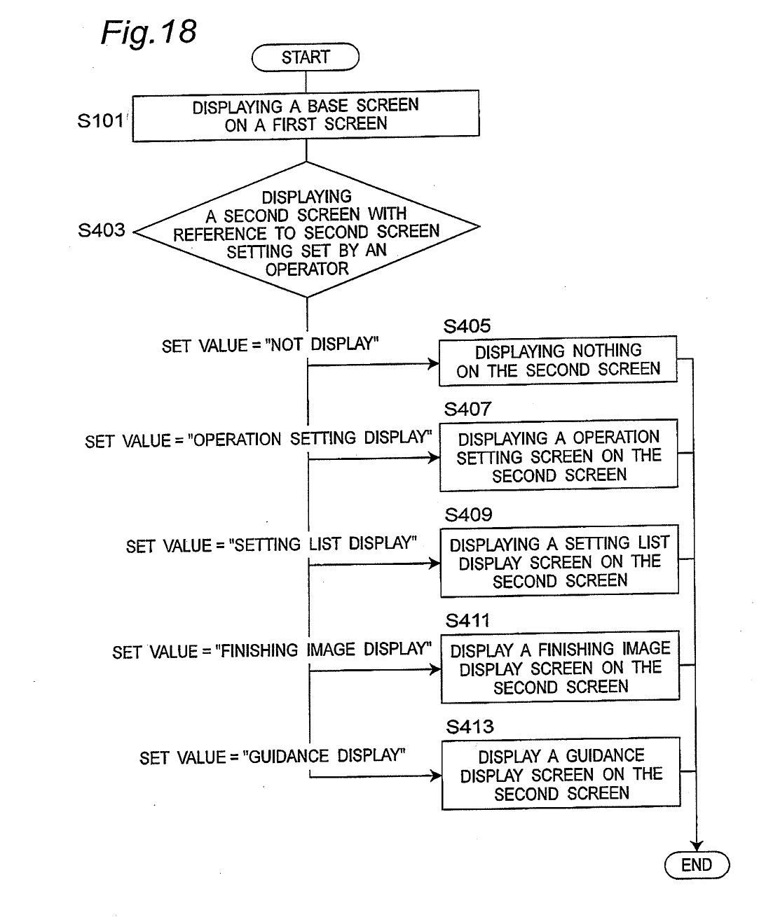

FIG. 18 is a flowchart of the screen display based on the operator's setting.

In step S101, the MFP 100 displays the base screen (FIG. 6) as the first screen 151 (FIGS. 3, 4) on the display unit 123.

In step S403, the MFP 100 branches the processing based on second-screen (right-screen) display content-setting set by the operator. If the operator selects the “not display” (“set value=not display” in step S403), the processing shifts to step S405. If the operator selects the “operation setting display” (“set value=operation setting display” in step S403), the processing shifts to step S407. If the operator selects the “setting list display” (“set value=setting list display” in step S403), the processing shifts to step S409. If the operator selects the “finishing image display” (“set value finishing image display” in step S403), the processing shifts to step S411. If the operator selects the “guidance display” (“set value=guidance display” in step S403), the processing shifts to step S413.

As described, in the MFP 100 according to the present embodiment, the operator can, in advance, set the contents to be displayed as the second screen 153.

(Viewing Angle Control Processing in Accordance with Displayed Contents)

The MFP 100 according to the present embodiment adjusts a range of visual direction (viewing angle), from which the screen can be visually recognized, in accordance with the contents of the displayed screen. This prevents the operator from performing an erroneous operation.

For example, when screens for operation setting (e.g., the paper selection screen as shown in FIG. 7) are displayed on both of the first screen 151 and the second screen 153, the second screen 153 includes operation keys to be operated by the operator similarly to the first screen 151. In such a case, the MFP 100 adjusts viewing angles so that the viewing angle of the second screen 153 may be a similar extent to the viewing angle of the first screen 151. On the other hand, when the second screen 153 displays a screen only intended to present information to the operator (e.g., the guidance screen as shown in FIG. 17), the operator does not perform the operation using the second screen 153, and thus, the MFP 100 adjusts the viewing angles so that the viewing angle of the second screen 153 is narrower than the viewing angle of the first screen 151.

(Flowchart of Viewing Angle Control Processing in Accordance with Displayed Contents)

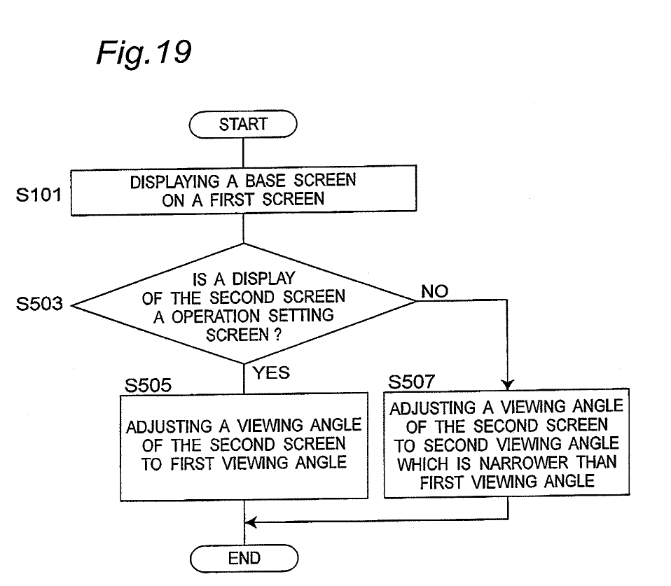

FIG. 19 is a flowchart of the viewing angle control processing in accordance with the displayed contents.

In step S101, the MFP 100 displays the base screen (FIG. 6) on the display unit 123 as the first screen 151 (FIGS. 3, 4).

In step S503, the MFP 100 determines whether or not displayed contents of the second screen 153 are of the screen for operation setting. If the MFP 100 determines that the displayed contents of the second screen 153 are of the screen for operation setting (“YES” in step S503), the processing shifts to step S505. If the MFP 100 determines that the displayed contents of the second screen 153 are not of the screen for operation setting (“NO” in step S503), the processing shifts to step S507.

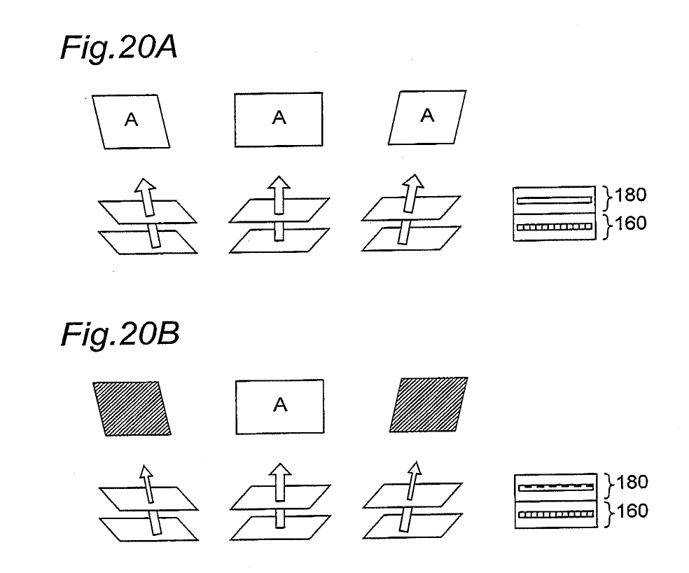

FIGS. 20A and 20B show diagrams for explaining a principle of viewing angle adjustment. FIG. 20A is a diagram showing a state where the viewing angle is adjusted to a wide viewing angle, and FIG. 20B is a state where the viewing angle is adjusted to a narrow viewing angle, which is narrower than the wide viewing angle. In the present example, a switch liquid crystal 180 is further arranged integrally on the operator side of the multiview liquid crystal 160. A part of the pixels in the switch liquid crystal 180 are switched to a status where the light is not transmitted therethrough, by which a part of light emitted from the multiview liquid crystal 160 does not reach the operator side. This allows the viewing angle to be adjusted. Moreover, by providing a plurality of such switch liquid crystals, it allows the viewing angle to be switched in a multi-stage manner by switching the operating switch liquid crystals.

The adjustment of viewing angles is not limited to the example of FIGS. 20A and 20B, and is also enabled by variably controlling pitches of the light transmissive portions and the light blocking portions of the parallax barrier 163, or by variably controlling an interval between the pixels 161 (FIG. 4) and the parallax barrier 163 in a direction perpendicular to, or in a direction parallel to a surface formed by the pixels 161.

The above-described multi-hierarchical screens simultaneous-display processing (FIG. 5), the selective lower-hierarchical screen display processing based on the operation frequency count amount (FIG. 11), the timer driven selective lower-hierarchical screens display processing (FIG. 12), the image display processing based on operator's setting (FIG. 18), and the viewing angle control processing in accordance with displayed contents (FIG. 19) are processings executable independently from one another. Two or more of these, however, can be combined as needed to realize one processing system. Since a method for realizing the foregoing is easy to those in the art, a description thereof is omitted.

According to the constitution of the embodiment of the present invention, the operator can view the plurality of screens of the different hierarchy levels by only moving himself/herself to a range of the divided viewing angles of the liquid crystal. This increases operability of the operator.

The embodiment of the present invention is usable as an image processing apparatus. In the image processing apparatus according to the present invention, operational convenience of the operator is increased, and effects of reduction in erroneous operation, shortened time required for operation and the like are brought about.

As this invention may be embodied in several forms without departing from the spirit of essential characteristic thereof, the present embodiment is therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

What is claimed is:

1. An image processing apparatus having a user interface display unit, the user interface display unit being made up of a plurality of screens of which displaying order constitutes a hierarchical structure, the image processing apparatus comprising:
the user interface display unit that simultaneously displays at least two screens on a same display screen, the at least two screens including a first screen and a second screen, the first screen and the second screen being displayed with visual directions being different from each other; and
a display screen determining unit that determines contents to be displayed on the first screen and the second screen,
wherein said display screen determining unit determines the content of the first screen based on set contents being set in the image processing apparatus and determines the content of the second screen such that the content of the second screen has a predetermined relationship with the determined content of the first screen, and cause said user interface display unit to display the first screen and the second screen in accordance with the determinations.

2. The image processing apparatus according to claim 1, wherein the predetermined relationship is a relationship that the second screen is selectable from the first screen.

3. The image processing apparatus according to claim 2, wherein the predetermined relationship is a relationship that the second screen is positioned at one lower hierarchy level in the hierarchical structure than the first screen and the second screen is selectable from the first screen.

4. The image processing apparatus according to claim 1, further comprising a user interface operation unit that receives an input of a setting operation,
wherein, when said user interface operation unit receives an input of an operation to display a screen which is positioned at one lower hierarchy level than the first screen and is selectable from the first screen, said display screen determining unit determines the screen positioned at the one lower-hierarchical level as the first screen in accordance with the input of the operation to display and determines a screen which is positioned at one lower hierarchy level than the determined first screen and is selectable from the determined first screen as the second screen.

5. The image processing apparatus according to claim 4, further comprising an operation frequency counting unit that records the input of the setting operation and counts frequency regarding the input of the setting operation,
wherein, when there is a plurality of screens which are positioned at one lower hierarchy level than the determined first screen and are selectable from the determined first screen, said display screen determining unit determines a screen which has a higher frequency than frequencies of the plurality of screen as the second screen based on the frequency counting performed by said operation frequency counting unit.

6. The image processing apparatus according to claim 3, further comprising a timer unit that measures time,
wherein, when there is a plurality of screens which are positioned at one lower hierarchy level than the determined first screen and are selectable from the determined first screen, said display screen determining unit determines a screen as the second screen so that the plurality of screens are switched at a predetermined interval based on time information outputted from said timer unit.

7. The image processing apparatus according to claim 1,
wherein each of the first screen and the second screen includes an operation key, respectively, and
wherein the operation key of the first screen and the operation key of the second screen in arranged on different positions on the same display screen.

8. The image processing apparatus according to claim 1, further comprising a user interface operation unit that receives an input of a setting operation,
wherein the predetermined relationship is a relationship that the second screen is a setting list display screen and the setting list display screen includes a setting item which is able to be set through the first screen.

9. The image processing apparatus according to claim 1, further comprising a user interface operation unit that receives an input of a setting operation,
wherein the predetermined relationship is a relationship that the second screen is a finishing image display screen on which a finishing image of a job being executed based on set contents including a setting item which is able to be set through the first screen is displayed graphically.

10. The image processing apparatus according to claim 1, wherein the predetermined relationship is a relationship that the second screen is a guidance screen on which a guidance regarding the first screen is displayed.

11. The image processing apparatus according to claim 1, further comprising a user interface operation unit that receives an input of a setting operation,
wherein, when said user interface operation unit receives an input of a setting operation of the second screen, said display screen determining unit, based on the input of the setting operation of the second screen, determines, as the second screen, one of:
a one lower hierarchy level screen which is selectable from the first screen;
a setting list display screen including a setting item which is able to be set through the first screen;
a screen on which a finishing image of a job being executed based on set contents including a setting item which is able to be set through the first screen is graphically displayed; and
a guidance screen on which a guidance regarding the first screen is displayed.

12. The image processing apparatus according to claim 11, further comprising:
a viewing angle determining unit that determines a viewing angle of the second screen; and
a viewing angle adjusting unit that changeably controls the viewing angle of the second screen,
wherein said viewing angle determining unit determines to change the viewing angle of the second screen in accordance with the content of the second screen determined by said display screen determining unit.
